(19) United States
(12) Patent Application Publication
(10) Pub. No.: US 2013/0169511 A1
(43) Pub. Date: Jul. 4, 2013

(54) WIRELESS TRANSMISSION DISPLAY SYSTEM AND CENTRAL PROCESSING DEVICE

(71) Applicant: ASUSTeK Computer Inc., Taipei (TW)

(72) Inventors: Tsung-Han CHENG, TAIPEI (TW); Yu-Sheng LIN, TAIPEI (TW)

(73) Assignee: ASUSTek COMPUTER INC., TAIPEI (TW)

(21) Appl. No.: 13/712,991

(22) Filed: Dec. 13, 2012

Related U.S. Application Data
(60) Provisional application No. 61/582,474, filed on Jan. 2, 2012.

(30) Foreign Application Priority Data
Oct. 16, 2012 (TW) 101138096

(51) Int. Cl. G09G 5/00

(52) U.S. Cl. CPC G09G 5/00
USPC 345/2.3

(57) ABSTRACT

A wireless transmission display system includes a central processing device and a terminal device. The central processing device includes a processor, a first display unit, and a first wireless transmission unit. The processor multitasks with respect to a first program and a second program. The first display unit displays a first image generated through execution of the first program. The terminal device includes an input unit, a second wireless transmission unit, and a second display unit. The input unit generates an operating instruction. The second wireless transmission unit transmits the operating instruction to the first wireless transmission unit. The processor executes the second program according to the operating instruction, and transmits a second image generated through execution of the second program to the second wireless transmission unit via the first wireless transmission unit. The second display unit displays the second image.

This application claims priority to U.S. Provisional Application Ser. No. 61/582,474, filed Jan. 2, 2012, and Taiwan Application Serial Number 101138096, filed Oct. 16, 2012 which is herein incorporated by reference.

### BACKGROUND

1. Technical Field

The present disclosure relates to a wireless transmission display system and a central processing device, and more particularly, to a wireless transmission display system in which computing resources are centralized in a central processing device.

2. Description of Related Art

A portable electronic apparatus that provides a specific computing function (e.g., a smartphone, personal digital assistant, portable navigation device, etc.) and a portable computer device (e.g., a notebook computer, tablet computer, etc.) usually includes its own processor for performing operations and various processing. With the rapid progress of technology, multi-core processor technology has been developed, allowing for the effective allocation of computing resources and efficient multitasking.

However, for a single user, the performance of each processor of all the portable electronic apparatuses he or she has purchased is typically not fully used. Therefore, when such a user purchases an additional portable electronic apparatus, the processor included therein may be regarded as an unnecessary cost burden. Ultimately, the idle performance of all the processors that the user has in his or her possession can not be effectively used, which is nothing more than a waste of resources. Moreover, it is necessary to install an operating system and a user interface in each of the portable electronic apparatuses that the user owns, and this also is associated with an unnecessary cost burden, as well as an unnecessary use of space that is occupied by the storage devices of the portable electronic apparatuses.

### SUMMARY

The disclosure provides a wireless transmission display system. The wireless transmission display system includes a central processing device and a first terminal device. The central processing device includes a processor, a first display unit, and a first wireless transmission unit. The processor is used to multitask with respect to a first program and a second program. The first display unit is used to display a first image generated through execution of the first program. The first wireless transmission unit is electrically connected to the processor. The first terminal device includes a first input unit, a second wireless transmission unit, and a second display unit. The first input unit is used to generate a first operating instruction. The second wireless transmission unit is used to transmit the first operating instruction to the first wireless transmission unit. The processor executes the second program according to the first operating instruction, and transmits a second image generated through execution of the second program to the second wireless transmission unit via the first wireless transmission unit. The second display unit is used to display the second image.

The wireless transmission display system provided by the disclosure entails centralizing computing resources at a central processing device, so that the central processing device can multitask with respect to programs corresponding to the central processing device and other terminal devices. Therefore, the other terminal devices can operate the corresponding programs and receive images corresponding to the programs by using the computing resources of the central processing device without having to be equipped with redundant processors, thereby reducing the overall cost of the wireless transmission display system. Moreover, the central processing device can make at least two terminal devices correspond to the same program by using a verification mechanism, so as to let both of the terminal devices operate the same program and receive the same image or different images respectively provided by the program.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a function block diagram of a wireless transmission display according to an embodiment of the disclosure;

FIG. 2 is a schematic diagram of a wireless transmission display system according to an embodiment of the disclosure; and

FIG. 3 is a schematic diagram of the wireless transmission display system according to another embodiment of the disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

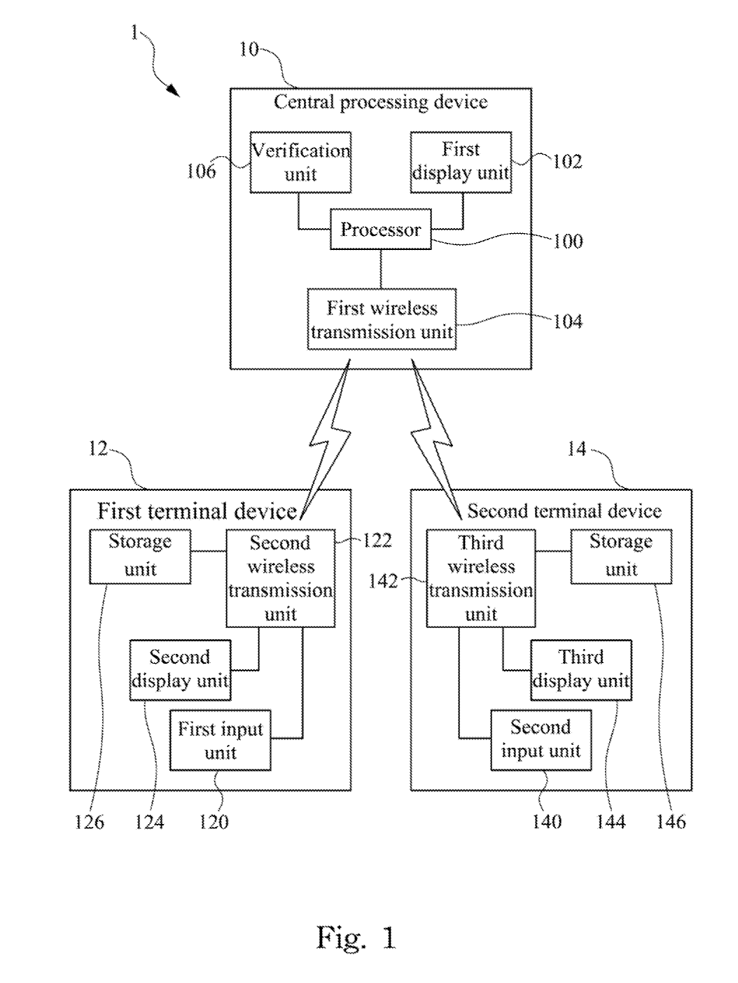

FIG. 1 is a function block diagram of a wireless transmission display system 1 according to an embodiment of the disclosure.

As shown in FIG. 1, the wireless transmission display system 1 includes a central processing device 10, a first terminal device 12, and a second terminal device 14.

The central processing device 10 of the wireless transmission display system 1 includes a processor 100, a first display unit 102, a first wireless transmission unit 104, and a verification unit 106. The first display unit 102, the first wireless transmission unit 104, and the verification unit 106 are electrically connected to the processor 100.

The first terminal device 12 of the wireless transmission display system 1 includes a first input unit 120, a second wireless transmission unit 122, a second display unit 124, and a storage unit 126. The first input unit 120, the second display unit 124, and the storage unit 126 are electrically connected to the second wireless transmission unit 122.

The second terminal device 14 of the wireless transmission display system 1 at least includes a second input unit 140, a third wireless transmission unit 142, a third display unit 144, and a storage unit 146. The second input unit 140, the third display unit 144, and the storage unit 146 are electrically connected to the third wireless transmission unit 142.

In an embodiment of the disclosure, the wireless transmission technology used by the first wireless transmission unit 104, the second wireless transmission unit 122, and the third wireless transmission unit 142 can conform to any wireless network protocol. Furthermore, any of the first wireless transmission unit 104, the second wireless transmission unit 122, and the third wireless transmission unit 142 can be a wireless communication base station, a wireless AP (Access Point), or another electronic unit having a function that enables wireless transmission or communication, but the disclosure is not limited in this regard.

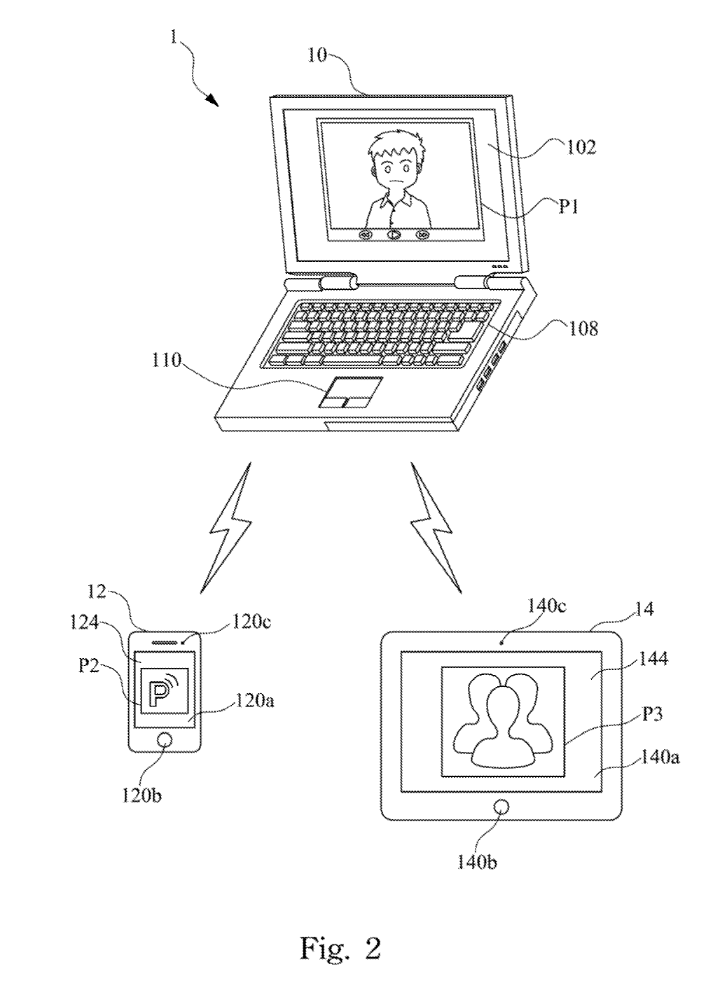

FIG. 2 is a schematic diagram of the wireless transmission display system 1 according to an embodiment of the disclosure.

As shown in FIG. 1 and FIG. 2, a notebook computer is taken as an example of the central processing device 10 of the wireless transmission display system 1, a smartphone is taken as an example of the first terminal device 12 of the wireless transmission display system 1, and a tablet. PC is taken as an example of the second terminal device 14 of the wireless transmission display system 1, but the disclosure is not limited in this regard.

In another embodiment of the disclosure, any of the central processing device 10 the first terminal device 12, and the second terminal device 14 of the wireless transmission display system 1 can be a smartphone, a PDA (Personal Digital Assistant, PDA), an Ultrabook, a Netbook, a tablet PC, or other electronic apparatus having a function that enables wireless transmission, but the disclosure is not limited in this regard.

With reference to FIG. 2, the central processing device 10 is used to multitask with respect to a first program, a second program, and a third program. For example, the first program is a video player program, the second program is a broadcast reception program, and the third program is an Internet chat program, but the disclosure is not limited in this regard.

In another embodiment of the disclosure, the first program is a first operating system (e.g., a computer operating system), the second program is a second operating system (e.g., a smartphone operating system), and the third program is a third operating system (e.g., a tablet PC operating system). The first display unit 102 of the central processing device 10 is used to display a first image P1 generated through execution of the first program.

Furthermore, the first input unit 120 of the first terminal device 12 includes a touch panel 120a, a physical button 120b, and a camera 120c, and the second input unit 140 of the second terminal device 14 includes a touch panel 140a, a physical button 140b, and a camera 140c, but the disclosure is not limited in this regard.

In another embodiment of the disclosure, both of the first input unit 120 of the first terminal device 12 and the second input unit 140 of the second terminal device 14 can include at least one of a physical button a keyboard, a mouse, a touch pad, a motion capture unit (e.g., a camera), and a voice-activated unit, but the disclosure is not limited in this regard.

In the embodiment of the disclosure, a user can generate a first operating instruction by the touch pad 120a, the physical button 120b, or the camera 120c of the first terminal device 12. When the central processing device 10 and the first terminal device 12 of the wireless transmission display system 1 have been paired to each other, the second wireless transmission unit 122 of the first terminal device 12 immediately transmits the first operating instruction to the first wireless transmission unit 104 of the central processing device 10. During execution of the second program, the processor 100 of the central processing device 10 executes the second program according to the first operating instruction, and transmits a second image P2 generated through execution of the second program to the second wireless transmission nit 122 of the first terminal device 12 via the first transmission unit 104. The second display unit 124 of the first terminal device 12 is used to display the second image P2.

Similarly, the user can generate a second operating instruction by the touch pad 140a, the physical button 140b, or the camera 140c of the second terminal device 14. When the central processing device 10 and the second terminal device 14 of the wireless transmission display system 1 have been paired to each other, the third wireless transmission unit 142 of the second terminal device 14 immediately transmits the second operating instruction to the first wireless transmission unit 104 of the central processing device 10. During execution of the third program, the processor 100 of the central processing device 10 executes the third program according to the second operating instruction, and transmits a third image P3 generated through execution of the third program to the third wireless transmission unit 142 of the second terminal device 14 via the first transmission unit 104. The third display unit 144 of the second terminal device 14 is used to display the third image P3.

In other words, the first program, the second program, and the third program executed by the processor 100 of the central processing device 10 are individual programs, and the first image P1, the second image P2, and the third image P3 respectively generated through execution of the first program, the second program, and the third program are displayed by the first display unit 102, the second display unit 122, and the third display unit 142, respectively.

With reference to FIG. 1, the storage unit 126 of the first terminal device 12 is used to store a first verification code, and the storage unit 146 of the second terminal device 14 is used to store a second verification code. The first verification code of the first terminal device 12 and the second verification code of the second terminal device 14 can be default verification codes when shipped from the factories and represent the identities of the first and second terminal devices 12, 14 respectively.

The verification unit 106 of the central processing device 10 includes verification data. In the embodiment of the disclosure, the second program and the third program are respectively set to pair the first verification code and the second verification code by the verification data. Therefore, when the central processing device 10 and the first terminal device 12 have not been paired to each other, or the central processing device 10 and the second terminal device 14 have not been paired to each other, if the second wireless transmission unit 122 of the first terminal device 12 or the third wireless transmission unit 142 of the second terminal device 14 attempts to transmit data to the first wireless transmission unit 104 of the central processing device 10, the verification unit 106 of the central processing device 10 will first verify the first verification code transmitted by the second wireless transmission unit 122 or the second verification code transmitted by the third wireless transmission unit 142.

It is only after the first verification code has been verified by the verification unit 106 of the central processing device 10 that the processor 100 executes the second program according to the first operating instruction and transmits the second image P2 generated through execution of the second program to the second wireless transmission unit 122 via the first wireless transmission unit 104. Similarly, it is only after the second verification code has been verified by the verification unit 106 of the central processing device 10 that the processor 100 executes the third program according to the second operating instruction and transmits the third image P3 generated through execution of the third program to the third wireless transmission unit 142 via the first wireless transmission unit 104.

In an embodiment of the disclosure, the storage unit 126 of the first terminal device 12 and the storage unit 146 of the second terminal device 14 are physical storage chips, but the disclosure is not limited in this regard. In another embodiment of the disclosure, the first terminal device 12 stores the first verification code and the second terminal device 14 stores the second verification code using software or firmware.

As shown in FIG. 2, the central processing device 10 of the wireless transmission display system 1 further includes a keyboard 108 and a touch pad 110. The user can generate a native end operating instruction by the keyboard 108 or the touch pad 110 of the central processing device 10. During execution of the first program, the processor 100 of the central processing device 10 executes the first program according to the native end operating instruction.

Hence, it is evident from the description above that the wireless transmission display system 1 of the disclosure can centralize the computing resources at the central processing device 10, so that the central processing device 10 can multitask with respect to the first program, the second program, and the third program corresponding to the central processing device 10, the first terminal device 12, and the second terminal device 14, respectively.

The central processing device 10 can operate the first program, the second program, and the third program respectively according to the native end operating instruction, the first operating instruction, and the second operating instruction, and display the first image P1 corresponding to the first program, the second image P2 corresponding to the second program, and the third image P3 corresponding to the third program on the first display unit 102 of the central processing device 10, the second display unit 124 of the first terminal device 12, and the third display unit 144 of the second terminal device 14, respectively. Therefore, the first terminal device 12 and the second terminal device 14 do not need to be equipped with processors, thereby reducing the overall cost of the wireless transmission display system 1.

Moreover, the wireless transmission display system 1 of the disclosure is not limited to only include the first terminal device 12 and the second terminal device 14. In practice, the number of terminal devices equipped for the wireless transmission display system 1 can be adjusted according to practical requirements or according to limitations with respect to the central processing device 10.

In another embodiment of the disclosure, the first terminal device 12 includes a first controller (not shown). The first controller of the first terminal device 12 includes a first instruction set. The first controller can process instructions included in the first instruction set. The first instruction set may not include the first operating instruction that is transmitted to the central processing device 10 by the first terminal device 12, and the first operating instruction does not need to be processed by the instructions of the first instruction set.

Similarly, in another embodiment of the disclosure, the second terminal device 14 includes a second controller (not shown). The second controller of the second terminal device 14 includes a second instruction set. The second controller can process instructions included in the second instruction set. The second instruction set may not include the second operating instruction that is transmitted to the central processing device 10 by the second terminal device 14, and the second operating instruction does not need to be processed by the instructions of the second instruction set.

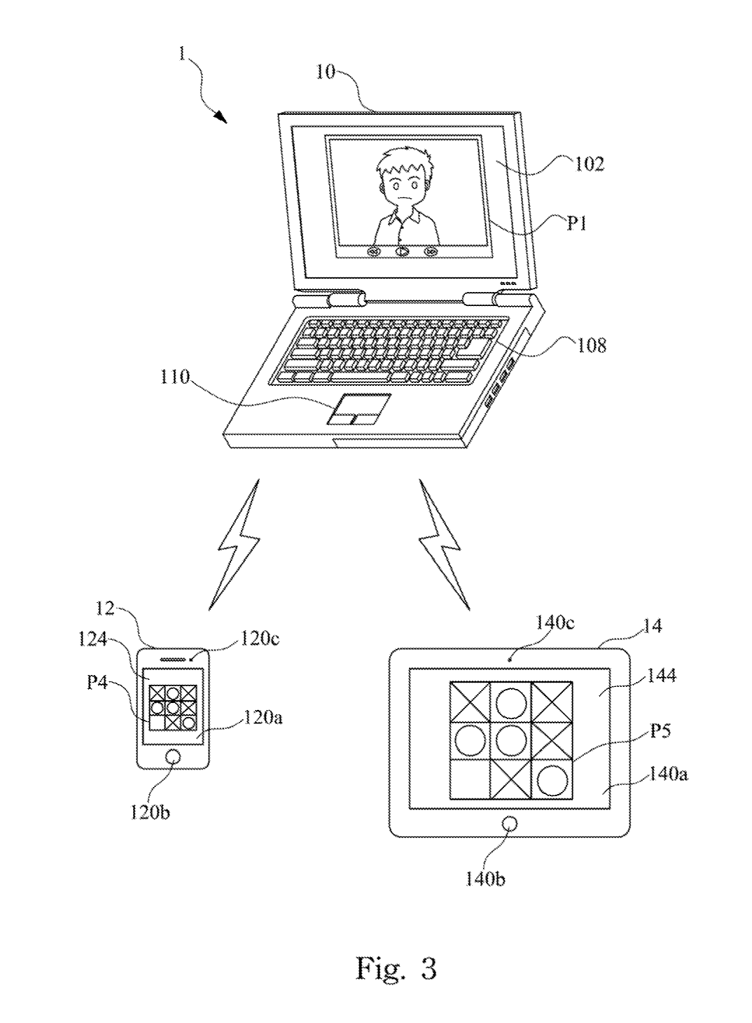

FIG. 3 is a schematic diagram of the wireless transmission display system 1 according to another embodiment of the disclosure.

As shown in FIG. 3, the wireless transmission display system 1 of this embodiment also includes the central processing device 10 the first terminal device 12, and the second terminal device 14. Moreover, components included in the processing device 10 the first terminal device 12, and the second terminal device 14 are similar to those of the embodiments in FIG. 1 and FIG. 2, and so an explanation in this regard will not be repeated.

Compared with the embodiment in FIG. 2, in the embodiment of FIG. 3, the verification data of the verification unit 106 of the central processing device 10 is set such that the second program is paired to the first verification code of the first terminal device 12 and also to the second verification code of the second terminal device 14.

Therefore, after the first verification code has been verified by the verification unit 106 of the central processing device 10, the processor 100 executes the second program according to the first operating instruction and transmits a second image P4 generated through execution of the second program to the second wireless transmission unit 122 via the first wireless transmission unit 104. The second display unit 124 then displays the second image P4. Similarly, after the second verification code has been verified by the verification unit 106 of the central processing device 10, the processor 100 executes the second program according to the second operating instruction and transmits a third image P5 generated through execution of the second program to the third wireless transmission unit 142 via the first wireless transmission unit 104. The third display unit 144 then displays the third image P5.

In other words, both the first operating instruction generated by the first terminal device 12 and the second operating instruction generated by the second terminal device 14 can operate the second program, both the second image P4 and the third image P5 are generated through execution of the second program, and the second image P4 and the third image P5 are respectively displayed by the second display unit 124 and the third display unit 144.

As shown in FIG. 3, the second program is a video game program, namely, tic-tac-toe. Therefore, the second image P4 displayed by the second display unit 124 and the third image P5 displayed by the third display unit 144 show the same content (i.e., similar game images), but the output resolutions of the second image P4 and the third image P5 can be different according to the sizes of the second display unit 124 and the third display unit 144, but the disclosure is not limited in this regard. In another embodiment of the disclosure, the second program is a FPS (First Personal Shooting) game program. That is, although both the first terminal device 12 and the second terminal device 14 can operate the second program, the viewing angles or user interfaces in the second image P4 and the third image P5 generated through execution of the second program are different.

In another embodiment of the disclosure, the central processing device 10 and at least one of the first terminal device 12 and the second terminal device 14 can operate the same program according to the same mechanism introduced above, and then the program outputs images with similar content or different content.

Through use of the present disclosure as set forth above, when the capability of the processor 100 of the central processing device 10 is insufficient, it is necessary only to upgrade the central processing device 10 in the wireless transmission display system 1 of the disclosure, and the first terminal device 12 and the second terminal device 14 can continue to be used as is, so as to reduce the cost of having to replace components in the wireless transmission display system 1.

According to the foregoing recitations of the embodiments of the disclosure, it can be seen that the wireless transmission display system provided by the disclosure entails centralizing computing resources at a central processing device, so that the central processing device can multitask with respect to programs corresponding to the central processing device and other terminal devices. Therefore, the other terminal devices can operate the corresponding programs and receive images corresponding to the programs by using the computing resources of the central processing device without having to be equipped with redundant processors, thereby reducing the overall cost of the wireless transmission display system. Moreover, the central processing device can make at least two terminal devices correspond to the same program by using a verification mechanism, so as to let both of the terminal devices operate the same program and receive the same image or different images respectively provided by the program.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A wireless transmission display system comprising:
a central processing device comprising:
a processor for multitasking with respect to a first program and a second program;
a first display unit for displaying a first image generated through execution of the first program; and
a first wireless transmission unit electrically connected to the processor; and
a first terminal device comprising:
a first input unit for generating a first operating instruction;
a second wireless transmission unit for transmitting the first operating instruction to the first wireless transmission unit, wherein the processor executes the second program according to the first operating instruction, and transmits a second image generated through execution of the second program to the second wireless transmission unit via the first wireless transmission unit; and
a second display unit for displaying the second image.

2. The wireless transmission display system of claim 1, wherein the first terminal device has a first verification code, and the central processing device further comprises a verification unit for verifying the first verification code.

3. The wireless transmission display system of claim 2, wherein the first terminal device further comprises a storage unit electrically connected to the second wireless transmission unit for storing the first verification code.

4. The wireless transmission display system of claim 2, further comprising a second terminal device comprising:
a second input unit for generating a second operating instruction;
a third wireless transmission unit for transmitting the second operating instruction to the first wireless transmission unit, wherein the processor executes the second program according to the first operating instruction and the second operating instruction, and transmits a third image generated through execution of the second program to the third wireless transmission unit via the first transmission unit; and
a third display unit for displaying the third image.

5. The wireless transmission display system of claim 1, wherein the first input unit is a physical button, a keyboard, a mouse, a touch panel, a motion capture unit, or a voice-activated unit.

6. The wireless transmission display system of claim 1, wherein the first program is a first operating system and the second program is a second operating system.

7. A central processing device for processing a first operating instruction generated by a first terminal device, the central processing device comprising:
a processor for multitasking with respect to a first program and a second program;
a first display unit for displaying a first image generated through execution of the first program; and
a first wireless transmission unit electrically connected to the processor for receiving the first operating instruction, wherein the processor executes the second program according to the first operating instruction, and transmits a second image generated through execution of the second program to the first terminal device via the first wireless transmission unit.

8. The central processing device of claim 7, further comprising a verification unit for verifying a first verification code of the first terminal device.

9. The central processing device of claim 7, wherein the first wireless transmission unit further receives a second operating instruction generated by a second terminal device, and the processor executes the second program according to the first operating instruction and the second operating instruction, and transmits a third image generated through execution of the second program to the second terminal device via the first wireless transmission unit.
